(19) United States
(12) Patent Application Publication
(10) Pub. No.: US 2020/0222950 A1
(43) Pub. Date: Jul. 16, 2020

(54) PRESSURE WASHING SYSTEM WITH TWO-STAGE OZONATION

(71) Applicant: Clean Team Holdings Inc., Pasadena, CA (US)

(72) Inventors: Alejandro Islas, San Gabriel, CA (US); William Lance Burrows, Big Bear Lake, CA (US)

(21) Appl. No.: 16/737,812

(22) Filed: Jan. 8, 2020

Related U.S. Application Data
(60) Provisional application No. 62/790,964, filed on Jan. 10, 2019.

(51) Int. Cl. B08B 3/02

(52) U.S. Cl. CPC B08B 3/026; B08B 2203/005

(57) ABSTRACT

A pressure washing system uses two-stage ozonation. The pressure washing system includes a container for holding water; a first ozone supply for supplying ozone to ozonate the water in the container in a first ozonation process; a pressure pump configured to pressurize the ozonated water; a second ozone supply for supplying ozone to further ozonate the water to generate two-stage ozonated water in a second ozonation process that is different from the first ozonation process; and a sprayer configured to receive the two-stage ozonated water.

### PRIORITY CLAIM

This application claims priority to and the benefit of U.S. provisional patent application No. 62/790,964 filed in the United States Patent and Trademark Office on Jan. 10, 2019, the entire content of which is incorporated herein by reference as if fully set forth below in its entirety and for all applicable purposes.

### INTRODUCTION

Ozone contains three atoms of oxygen (O₃) that is different than the two atoms oxygen (O₂) in breathable air (hereafter “air”). Ozone may also be known as “activated oxygen” or O₃. The oxidizing properties of ozone can reduce or eliminate taste and odor problems in air or water. Furthermore, ozone is a powerful sterilant that can be used as an effective disinfectant to treat air, water, or other fluids. In some applications, ozone effectively kills bacteria, viruses, microorganisms, spores, and many other pathogens, while it removes dissolved organic materials by oxidative processes. Ozone has been used to treat and disinfect water supply.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide a pressure washing system using two-stage ozonation. The pressure washing system includes a container for holding water; a first ozone supply for supplying ozone to ozonate the water in the container in a first ozonation process; a pressure pump configured to pressurize the ozonated water; a second ozone supply for supplying ozone to further ozonate the water to generate two-stage ozonated water in a second ozonation process that is different from the first ozonation process; and a sprayer configured to receive the two-stage ozonated water.

In some aspects, the pressure washing system further includes a water treatment device located inside the container, configured to receive ozone from the first ozone supply and distribute the ozone into the water. In some aspects, the water treatment device includes a porous tube configured to diffuse the ozone. In some aspects, the porous tube is configured in at least one of: a coiled shape; a helical shape; a spiral shape; a circular shape; or a wound shape. In some aspects, the first ozone supply and the second ozone supply have different configurations.

Aspects of the present disclosure provide a pressure washing method. The method diffuses, in a first ozonation process, ozone into water held in a water container to generate ozonated water. Then, the method increases, in a second ozonation process, ozone concentration of the ozonated water. Then, the method generates a high pressure stream of the ozonated water. In some aspects, the first ozonation process occurs inside the water container, and the second ozonation process occurs outside of the water container

### BRIEF DESCRIPTION OF THE DRAWINGS

FIGS. 1 is a conceptual diagram illustrating a pressure washing system with two-stage ozonation according to one embodiment.

FIG. 2 is a diagram conceptually illustrating an exemplary ozone supply.

FIG. 3 is a diagram conceptually illustrating another exemplary ozone supply.

FIG. 4 is a diagram illustrating a top view and a perspective view of an exemplary water treatment device.

FIG. 5 is a flow chart illustrating an exemplary pressure washing method using ozone according to an embodiment.

### DETAILED DESCRIPTION

Referring now to the drawings, embodiments of systems and methods of a water treatment system using ozone as a sterilant or disinfectant are disclosed in the present disclosure. Aspects of the present disclosure provide a water treatment system that can generate ozonated water using a vacuum operated injector with reduced vacuum switch lockup. In some aspects of the disclosure, the water treatment system has a tubing arrangement (hereafter “tubing”) that optimizes ozone distribution efficiency.

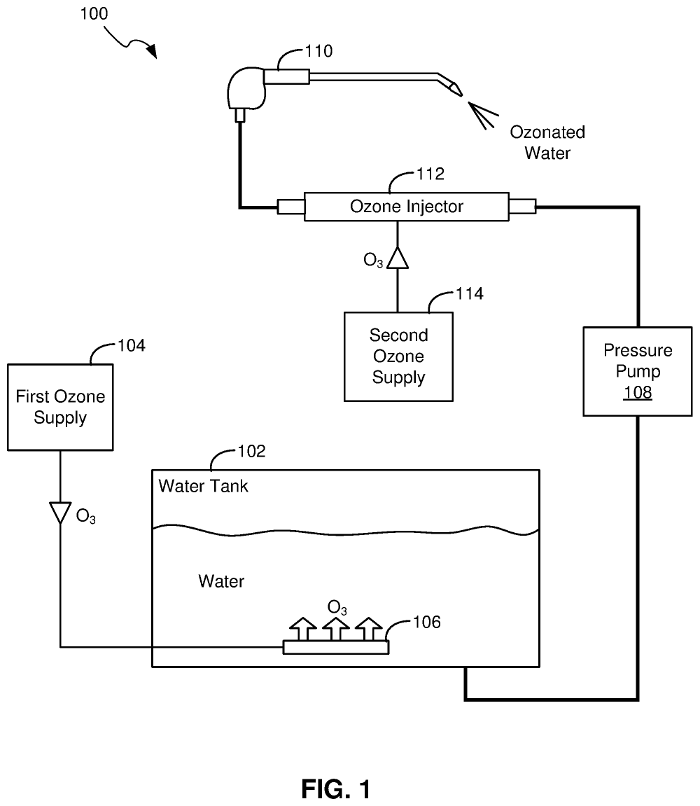

FIG. 1 is a conceptual diagram illustrating a pressure washing system 100 using two-stage ozonation according to one embodiment. Referring to FIG. 1, the pressure washing system 100 includes a container 102 (e.g., water tank) for storing a substantial amount of water or any fluid suitable for a pressure washing system. In a first stage ozonation process, the pressure washing system 100 has a first ozone supply 104 configured to generate ozone (e.g., O₃) that is diffused into the water in the container 102 using a water treatment device 106. The water treatment device 106 may be located at the bottom or lower portion of the water container 102 to promote more effective ozone diffusion. The water treatment device 106 is configured to discharge, distribute, and/or diffuse an effective amount of ozone (O₃) for treating (e.g., disinfecting) the water in the container 102. In some embodiments, one or more water treatment devices 106 may be installed in the water container 102 to further improve ozone diffusion efficiency. The ozonated water can be used for disinfecting objects, surfaces, and/or areas. In one embodiment, the water treatment device 106 can discharge a predetermined amount of air mixture containing a certain volume percentage of ozone. In one example, the air mixture may have an ozone concentration up to about 0.3 part per million (ppm). In other examples, the air mixture may have other desired ozone concentration.

For a second stage ozonation process, the pressure washing system 100 includes an ozone injector 112 configured to inject ozone into a flow of water. The ozone injector 112 receives ozone produced by a second ozone supply 114, and injects or diffuses the ozone into the water flow to further increase the ozone concentration of the water. Because the first stage ozonation process already raised the oxygen level of the water, the ozone diffusion efficiency of the second stage ozonation at the ozone injector 112 is increased or improved. The pressure washing system 100 has a pressure pump 108 that receives the once-ozonated water from the water tank 102, pressurizes the water, and supplies the pressurized ozonated water to the ozone injector 112 for further ozonation. A sprayer 110 may be connected to the ozone injector 112 to discharge the two-stage ozonated water. The pressure pump 108 may be any type of pump configured to provide the desired pressure and flow rate. In some examples, the pressure pump 108 may be a direct drive horizontal triplex plunger pump, a direct drive vertical axial cam pump, or the like.

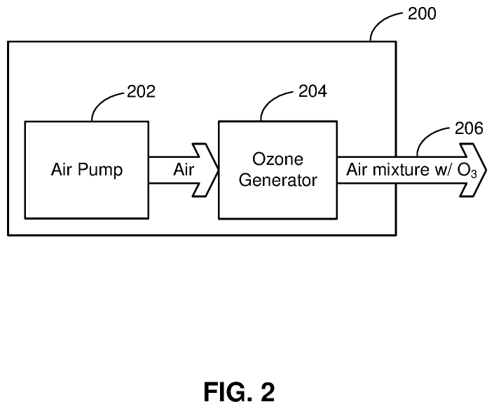

FIG. 2 is a diagram illustrating an exemplary ozone supply 200. In some examples, the ozone supply 200 may be used as the first ozone supply 104 and/or the second ozone supply 114 in the pressure washing system 100. The ozone supply 200 includes an air pump 202 and an ozone generator 204. In one example, the ozone generator 204 may be a dielectric barrier discharge ozone generator. In operation, the air pump 202 generates an air stream that is mixed with ozone produced by the ozone generator 204. The air stream may have a pressure greater than atmospheric pressure or any desired pressure. In some examples, the air pressure may be up to 2.5 pounds per square inch (psi). The ozone-mixed air stream 206 may be supplied to the water treatment device 106 to treat the water in the water container 102.

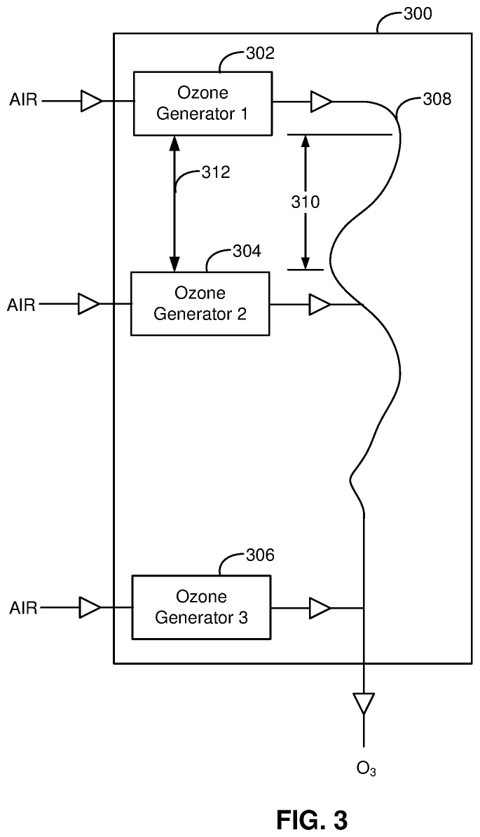

FIG. 3 is a diagram conceptually illustrating another exemplary ozone supply 300. In some examples, the ozone supply 300 may be used as the first ozone supply 104 and/or the second ozone supply 114. In one example, the ozone supply 300 may include two or more separate ozone generators. The ozone generators may be dielectric barrier discharge ozone generators. Three exemplary ozone generators 302, 304, and 306 are shown in FIG. 3. These ozone generators may be any suitable ozone generators configured to produce or supply ozone (O₃). Air containing oxygen enters the ozone generators 302, 304, and 306 at an inlet, and the ozone generators provide ozone or ozone-mixed airstream at an outlet. Ozone from each ozone generator 302, 304, and 306 is conveyed or carried via tubing 308 to an outlet of the ozone supply 300. In some examples, a section 310 of the tubing 308 between two adjacent ozone generators (e.g., ozone generators 302 and 304) are longer in length than the physical distance 312 between adjacent ozone generators. In some embodiments, the tubing 308 may be arranged to avoid any sharp or acute bends (e.g., a bend less than 90 degrees). For example, a section of the tubing 308 between two adjacent ozone generators 302 and 304 is arranged in a tortuous shape (e.g., loop, spiral, winding, or the like) without any acute bend. By extending the length of the tubing 308 without any acute bend between the ozone generators, ozone distribution may be increased or optimized. The tortuous shape (e.g., loops) of the tubing 308 may promote an even ozone distribution for better performance. For example, the tortuous shape may decrease oxidation collection in the ozone generator's dielectric chamber, system tubing, and fittings. That is, the tortuous shape may reduce damage and wear of the system and promote a longer life for the various components that come in contact with the ozone gas. Furthermore, looping the tubing allows for optimal use of the ozone generated and increases the oxidation-reduction potential (ORP) levels in the ozonated water that is created by the system.

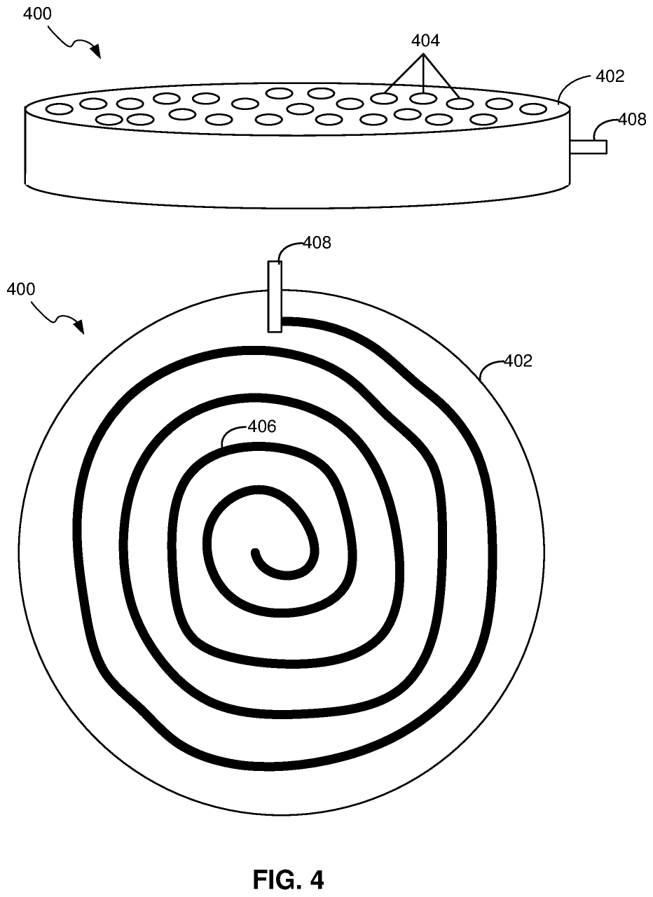

FIG. 4 is a diagram illustrating a top view and a perspective view of an exemplary water treatment device 400. In some embodiments, the water treatment device 400 may be used as the water treatment device 106 in the pressure washing system 100 to diffuse ozone into water. The water treatment device 400 has a housing 402 with a plurality of openings 404. The housing 402 may be made of any suitable material such as metal. The top part of the housing 402 is not shown in the top view in order to illustrate a porous tube 406 contained in the housing 402. While exemplary openings 404 are shown on the top of the housing, openings of the same or different shapes and sizes may be present on the top, side, and/or bottom portions of the housing 402.

The plurality of openings 404 allow ozone or ozone-mixed air to egress from the device during the first stage ozonation process. The porous tube 406 has an inlet, connector, or coupler 408 that may be connected to the first ozone supply 104 via a hose, pipe, or tubing. The porous tube 406 when extended is substantially longer than the, height, length, and/or width of the housing 402. In this particular example, the porous tube 406 is coiled to fit into the housing 402. The openings 404 allow water to enter the water treatment device 400 when it is submerged in water such that the porous tube 406 is submerged in water during an ozonation process.

In some embodiments, the porous tube 406 may have other tortuous configurations like a wound shape, helical shape, bend shape, circular shape, rolled shape, spiral shape, and the like. By maximizing the length of the porous tube 406 that can be fitted into the housing 402, a ratio of the surface area of the porous tube 406 to the volume of the housing 402 can be increased or maximized. Therefore, the efficiency or rate of ozone diffusion or ozonation of the water treatment device 400 can be increased. In some embodiments, the water treatment device 400 can provide about 100 liters of ozone-mixed air per minute. In one example, the water treatment device can provide up to 40 LPM (liter per minute) of ozone-mixed air to a small container (e.g., 5-gallon container). In another example, the water treatment device can provide up to about 110 LPM of ozone-mixed air to a large container (e.g., 55 gallon container). During operation, the porous tube 406 can diffuse a large amount of ozone-mixed air bubbles into the water to achieve effective ozonation. In some embodiments, the water treatment device 400 may be configured with two or more porous tubes 406.

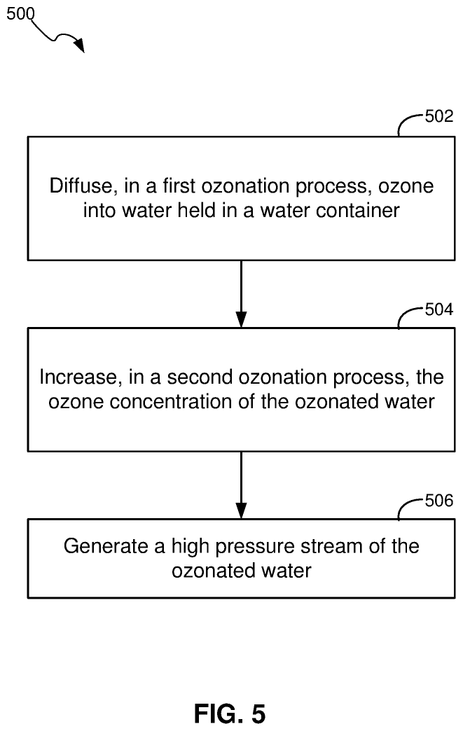

FIG. 5 is a flow chart illustrating an exemplary pressure washing method 500 using two-stage ozonation according to some embodiments. As described below, some or all illustrated features may be omitted in a particular implementation within the scope of the present disclosure, and some illustrated features may not be required for implementation of all embodiments. In some examples, the method 500 may be carried out using the pressure washing system 100 described above in relation to FIGS. 1-4.

At block 502, in a first ozonation process, the pressure washing system 100 diffuses ozone into water stored in a water container. For example, the pressure washing system 100 may use the first ozone supply 104 and water treatment device 106 to diffuse ozone into the water in the container 102. This process may be called the first ozonation process.

At block 504, in a second ozonation process, the pressure washing system 100 increases the ozone concentration of the ozonated water. For example, the pressure washing system 100 may use the second ozone supply 114 and ozone injector 112 to further diffuse ozone into the ozonated water to increase ozone concentration. This process may be called the second ozonation process that is different from the first ozonation process in terms of locations and time of operation.

At block 506, the pressure washing system 100 generates a high pressure stream of the ozonated water. For example, the pressure washing system 100 may use the pressure pump 108 and sprayer 110 to generate a high pressure stream of ozonated water.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A pressure washing system using two-stage ozonation, comprising:
a container for holding water;
a first ozone supply for supplying ozone to ozonate the water in the container in a first ozonation process;
a pressure pump configured to pressurize the ozonated water;
a second ozone supply for supplying ozone to further ozonate the water to generate two-stage ozonated water in a second ozonation process that is different from the first ozonation process; and
a sprayer configured to receive the two-stage ozonated water.

2. The pressure washing system of claim 1, further comprising:
a water treatment device located inside the container, configured to receive ozone from the first ozone supply and distribute the ozone into the water.

3. The pressure washing system of claim 2, wherein the water treatment device comprises a porous tube configured to diffuse the ozone.

4. The pressure washing system of claim 3, wherein the porous tube is configured in at least one of:
a coiled shape;
a helical shape;
a spiral shape;
a circular shape; or
a wound shape.

5. The pressure washing system of claim 1, the first ozone supply and the second ozone supply have different configurations.

6. A pressure washing method, comprising:
diffusing, in a first ozonation process, ozone into water held in a water container to generate ozonated water;
increasing, in a second ozonation process, ozone concentration of the ozonated water; and
generating a high pressure stream of the ozonated water.

7. The pressure washing method of claim 6, wherein the first ozonation process occurs inside the water container, and the second ozonation process occurs outside of the water container.
